(19) United States
(12) Patent Application Publication
(10) Pub. No.: US 2001/0032374 A1
(43) Pub. Date: Oct. 25, 2001

(54) Fluid controlled luggage handle

(75) Inventor: Chung-Hsien Kuo, Pan-Chiao City (TW)

Correspondence Address: Dougherty & Troxell, ONE SKYLINE PLACE, 5205 LEESBURG PIKE, SUITE 1404, FALLS CHURCH, VA, 22041, US

(73) Assignee: CHAW KHONG TECHNOLOGY CO., LTD.

(21) Appl. No.: 09/799,677

(22) Filed: Mar. 7, 2001

(30) Foreign Application Priority Data
Apr. 21, 2000 (TW) 089206591

(51) Int. Cl. E05B 1/00

(52) U.S. Cl. 16/113.1

(57) ABSTRACT

A fluid controlled luggage handle is introduced; this luggage handle uses an outer tube as an air/liquid buffer tank. Through the maneuver of the internal components of the main piston, which in turn is firmly fastened to the lower end of the inner tube of the supporting frame of the luggage handle, and also through the interaction between a control button on the handle grip and the auxiliary piston installed within the main piston, the inner tube is capable of moving upward and downward entirely up to the user's liking. The inner tube's maneuverability also reflects the luggage handle's mobility. By easily pressing down a control button on the luggage handle, the user can raise and lower the luggage handle whenever and wherever he/she desires. With this design, the technical bottleneck which long hindered the luggage manufacturers from reaching an absolute no-stroke luggage handle has now been removed.

### BACKGROUND OF THE INVENTION

1. Field of the Invention

The present invention relates to a luggage handle and more particularly to a fluid control luggage handle whose protraction and retraction are controlled by the manipulation of the fluid maneuver.

2. Description of Related Art Luggage handle plays a very important role in the evaluation of a wheeled luggage because the quality of the handle mechanism could influence the luggage's quality and the price of the luggage itself. Therefore, merchants all over the world often introduce new releases of luggage handles to the general public in hope to attract more customers. Generally, the luggage handles in the market can be classified as single-stroke handles, two-stroke handles, multi-stroke handles, and no-stroke handles. The multi-stroke handles and the no-stroke handles usually have very complicated internal structures which lead to high costs of manufacturing and high probability of failures. The luggage consumers worldwide frequently unleash their complaints about their luggage's malfunctioning to the luggage manufacturers. Nevertheless, no current technology so far developed can ever manage to resolve these problems and remedy the situation. A new direction of luggage handle design has to be pursued.

### SUMMARY OF THE INVENTION

The primary object of the present invention is to provide a workable model of fluid controlled luggage handle which can eliminate all the mechanical problems encountered by the traditional stroke-related luggage handles.

Another object of the present invention is to provide a fluid controlled luggage handle which not only is capable of fulfilling its intended protraction-retraction locking functions just as well as, or even better than, the no stroke luggage handles in the prior art, but also possesses a much simpler internal structure and a much more easier way to operate as compared to the conventional stroke-related luggage handles.

In order to achieve the above mentioned objects, effects, and features, a fluid controlled luggage handle comprises an outer tube which is installed at the back of the luggage, an inner tube which is capable of sliding itself freely inside the outer tube, a main piston installed at the bottom of the inner tube, and an auxiliary piston installed inside the main piston so that, by controlling the button on the top of the handle, the auxiliary piston can slide up and down freely inside the main piston. Followed by the sliding action of the auxiliary piston, a valve inside the main piston can be opened or closed to control the sliding stroke of the inner tube inside the outer tube so as to further make changes to the luggage handle's multiple operating altitudes and to allocate the luggage handle to its various locking positions.

The above mentioned and other additional advantages and characteristics of the present invention will become apparent after a reading of the following detailed description of the subject matter made in conjunction with the accompanying drawings.

### BRIEF DESCRIPTION OF THE DRAWINGS

FIG. 1 is a schematic cross-sectional view of a fluid controlled luggage handle according to the present invention;

FIG. 2 is a cross-sectional view of the first state of use in a preferred embodiment of the luggage handle according to the present invention;

FIG. 3 is a cross-sectional view of the second state of use in a preferred embodiment of the luggage handle according to the present invention;

FIG. 4 is a cross-sectional view of the first state of use in a second preferred embodiment of the luggage handle according to the present invention;

FIG. 5 is a cross-sectional view of the second state of use in a second preferred embodiment of the luggage handle according to the present invention;

FIG. 6 is a cross-sectional view of the first state of use in a third preferred embodiment of the luggage handle according to the present invention; and

FIG. 7 is a cross-sectional view of the second state of use in a third preferred embodiment of the luggage handle according to the present invention.

### DETAILED DESCRIPTION OF THE INVENTION

The main feature of the fluid controlled luggage handle of the present invention is to use fluid to control the upward and downward strokes of the luggage handle. The term “Fluid” herein referred is related both to the pneumatic and the hydraulic controls. In order to simplify the description, the following embodiments use the pneumatic control luggage handle as an example for a detailed description of the concept. In this example, an outer tube is taken as an air tank; a main piston is installed at the bottom of the inner tube, and the beginning and the end of the main piston stroke are controlled by a button on the top of the luggage handle, whereby the handle is raised or lowered to its various desired positions.

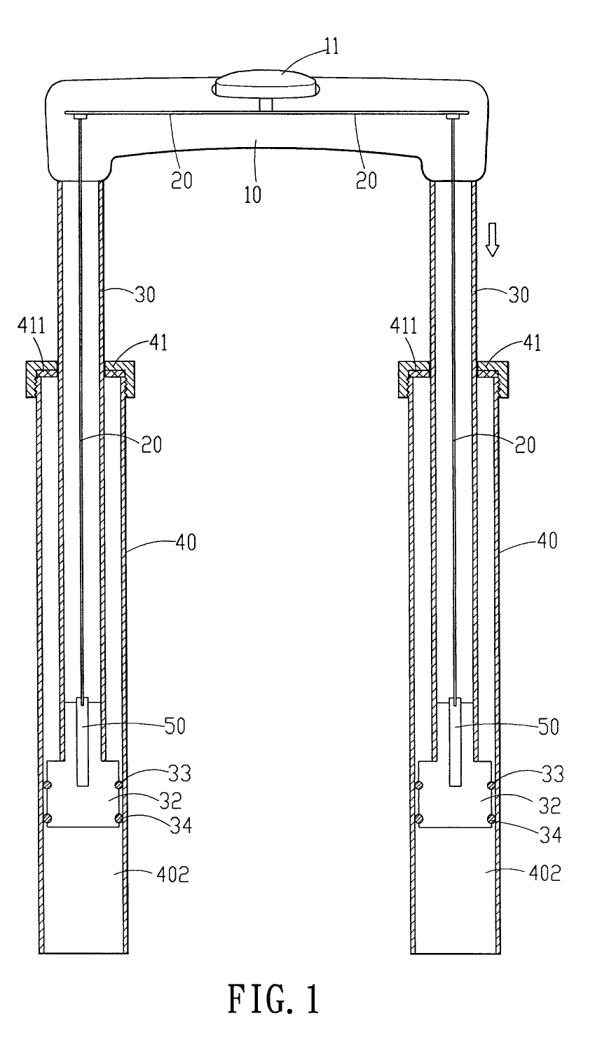

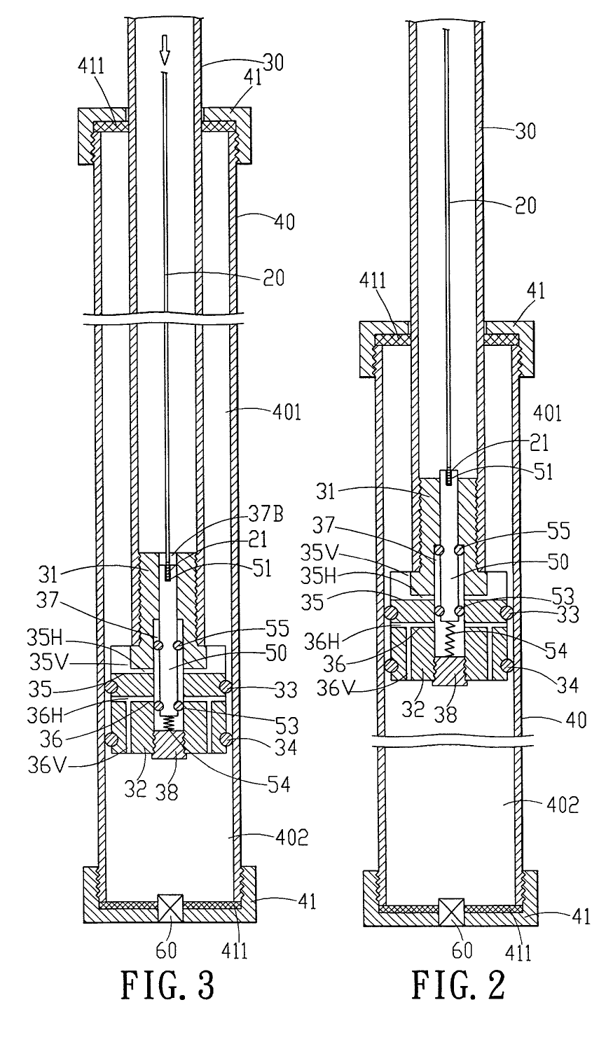

Refer to FIGS. 1 and 2, the fluid controlled luggage handle of the present invention comprises a handle holder 10, a button 11 on the handle holder 10, two rigid drawing elements 20 connected to the button 11 and extended down into the two inner tubes 30, two outer tubes 40 installed at the back of the luggage wherein each inner tube 30 can slide freely therein, two main pistons 32 wherein each is fixedly installed at the bottom of each inner tube 30, two auxiliary pistons 50 wherein each is installed inside each of the two main pistons 32, two first air-tight O-rings 33 and two second air-tight O-rings 34 wherein each first air-tight O-rings 33 and each second air-tight O-rings 34 are placed separately to encircle each main pistons 32, and two upper air channels 35 and two lower air channels 36, wherein one upper channel 35 and one lower channel 36 are diversely provided within each main piston 32 (see FIG. 2). To make each of the two outer tubes 40 an enclosed air tank, O-rings 411 are provided at both the top and the bottom ends of the two outer tubes 40 and are affixed to the outer tube 40 through the screwing operation of the upper and the lower covers 41 onto the four threaded outer rims provided at the two outer tubes 40's two ends. The main piston 32 is screw-fixed to the bottom of the inner tube 30 by its upper smaller-diameter portion 31, while the auxiliary piston 50 is inserted into the central pit 37 of the main piston 32. Two airtight O-rings 53 and 55 are provided separately around the auxiliary piston 50. The upper portion 51 of the auxiliary piston 50 is screw-fixed to the lower portion 21 of the rigid drawing element 20, and the upper portion of the rigid drawing element 20 is connected to the button on the handle 10. A spring 54 is disposed between the lower end of the auxiliary piston 50 and the bottom end of the central pit 37 of the main piston 32. The lower portion of the central pit 37 is originally open but later screw-fixed and locked by a block 38 so as to maintain the positions of the two air-tight O-rings 53 and 55 on the auxiliary piston 50 in such a manner that the upper air-tight O-ring 55 is positioned at the top ceiling of the central pit 37 of the main piston 32, and the lower air-tight O-ring 53 is positioned between the horizontal air channel 35H of the upper air channel 35 and the horizontal air channel 36H of the lower air channel 36 of the main piston 32. With such an arrangement, the upper air tank 401 and the lower air tank 402 are separated by the main piston 32 so that they are not mutually connected, therefore the main piston 32 will stay still, and since the main piston 32 is affixed to the lower end of the inner tube 30, the inner tube 30 is also hereby locked into position. This fluid-controlled luggage handle mechanism's immobile situation will remain until the button 11 on the handle 10 is pressed by the user. After the button 11 on the handle 10 is pressed, the rigid drawing element 20 will be depressed, and subsequently the spring 54 will also be compressed by the auxiliary piston 50. At this instant, the two airtight O-rings 53 of the auxiliary pistons 50 each will be lowered to below the horizontal air channel 36H of the lower air channel 36 within each main piston 32 inside the two outer tubes 40 (see FIG. 3). In this manner, the upper air channel 35 and the lower air channel 36 are in fluid communication by way of a path which goes from the vertical air channel 35V, the horizontal air channel 35H (here, the air channels 35V and 35H constitute the upper air channel 35), the central air pit 37, the horizontal air channel 36H, and the vertical air channel 36V of the lower air channel 36. The communication between the upper air tank 401 and the lower air tank 402 are thus achieved. For the user, however, from this step on, by firstly pressing the button 11 on the top of the handle 10, he/she can pull up or push down the luggage handle at will and allows the inner tube 30 to slide up and down freely inside the outer tube 40. That is to say, in this instance, the luggage handle can be raised or lowered entirely to the user's liking. Nevertheless, when the button is released, the inner tube 30 will be stopped at an arbitrary instant position inside the outer tube 40, and the handle's mobile height is also temporarily frozen thereat. From the above description, it is perceivable that the fluid controlled luggage handle herein disclosed is indeed a new no-stroke luggage handle design.

It is noted that the present invention uses an outer tube 40 which serves as an enclosed fluid tank; yet, in spite of the many different maneuverable height options of the main piston 32, the outer tube 40 can always be divided into two air tanks, one the upper air tank 401 and the other the lower air tank 402. For the preferred embodiment mentioned above, both the upper air tank 401 and the lower air tank 402 are airtight structures. However, for another alternative preferred embodiment of the present invention, a one-way valve 60 can be provided at the bottom of the outer tube 40 such that when the air pressure in the outer tube 40 is low, the ambient atmosphere can replenish more fresh air into the lower air tank 402 through the medium of the one-way valve 60.

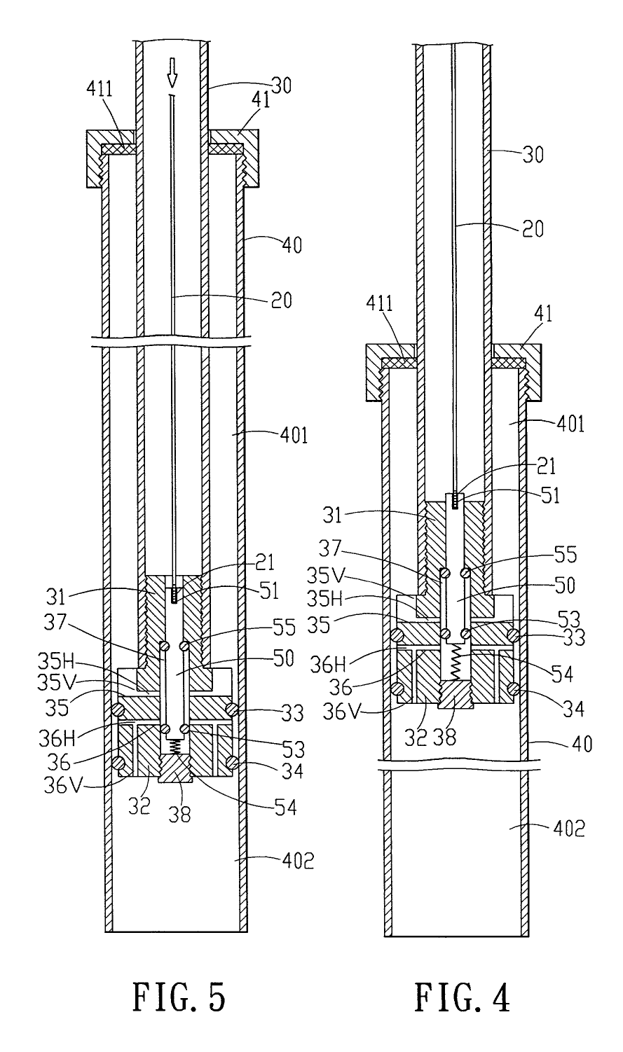

The third preferred embodiment of the present invention is shown in FIGS. 4 and 5. This embodiment has a similar structure to that of the first one, but this time only the upper air tank 401 is airtight; the lower air tank 402 is open. In this embodiment, the one-way valves 60 at the bottom of the outer tanks 40, the lower O-rings 411 and the lower covers 41 of the outer tubes 40 are all omitted in order for the lower air tanks 402 to be in fluid communication with the ambient environment. Other components can also be accordingly adjusted to facilitate this new design.

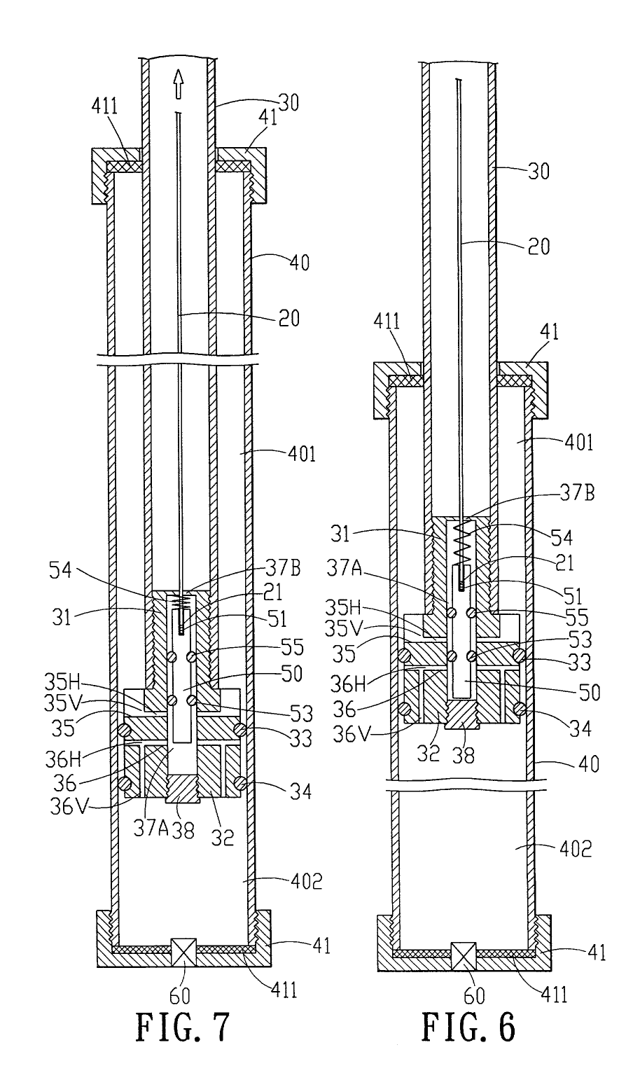

While still another preferred embodiment is shown in FIGS. 6 and 7. Its main structure is similar to that of the first embodiment except that the manipulation direction is reversed. In the first embodiment, the user presses the push button down so as to depress the rigid drawing elements 20 and thereby controls the luggage handle's maneuver; while in the current embodiment, the user pulls the rigid drawing elements 20 up in order to move the handle. Due to this change of design, the spring 54, originally provided at the bottom of the auxiliary piston 50, is now relocated to the top of the central pit 37A, and the newly added opening 37B of the central pit 37A is punctured in such a manner that only one machine element the rigid drawing element 20 is capable of marginally passing through the peephole 37B. The current embodiment can also achieve the same effects as those accomplished in the first embodiment.

In conclusion, the fluid controlled luggage handle of the present invention has a simpler structure than a conventional no-stroke handle design; it is easy to assemble and unlikely to fail; thus the present invention has practical values, and it satisfies the requirements of a utility invention.

Although the present invention has been described with reference to specific embodiments, this description is not meant to be construed by the reader in a limited sense. Various modifications from the herein disclosed embodiments along with many other alternative embodiments will become apparent to those skilled in the art. It is, therefore, contemplated that the appended claims will cover all the modifications which eventually fall into the scope of the present invention.

What is claimed is:

1. A fluid controlled luggage handle comprising
an outer tube which serves as an airtight fluid tank;
an inner tube which can slide freely therein; and
a main piston installed at the bottom of the inner tube;
wherein the beginning and the end of the main piston stroke are controlled by the activating pressure imposed on a button on the handle and consequently the luggage handle is raised or lowered to positions.

2. A fluid controlled luggage handle, comprising
an outer tube installed at a back of the luggage;
an inner tube which can slide freely in the outer tube;
a main piston installed at a bottom of the inner tube; and
an auxiliary piston installed in the main piston;
wherein the auxiliary piston is coupled to, and controlled by, a button on the handle so as to slide itself up and down within the main piston; thereby controls the opening and closing of a valve inside the main piston at the bottom of the inner tube, which further controls the upward and downward strokes of the inner tube within the outer tube, a no-stroke luggage handle's maneuver is thus achieved.

3. A fluid controlled luggage handle which comprises
a handle holder;
a button on the handle holder;
two outer tubes installed at a back of the luggage;
two inner tubes which each of them can slide freely within each outer tube;
two rigid drawing elements connected to the button and extended down into the two inner tubes;
a main piston at a bottom of each inner tube;
an auxiliary piston installed inside each main piston;
a first O-ring and a second O-ring surrounding each of the main piston;
an upper channel and a lower channel provided in each main piston; and
a third and fourth O-rings encircling the auxiliary piston;
wherein an upper portion of the auxiliary piston connects to a rigid drawing element; an upper portion of the rigid drawing element connects to the button on the handle, and a spring longitudinally disposed between a lower end of the auxiliary piston and a bottom end of a central pit of the main piston, which is for maintaining a position of the fourth O-ring of the auxiliary piston between a horizontal channels of the upper channel and a horizontal channel of the lower channel and thereby separating the upper and the lower channels independently so that the upper fluid tank and the lower fluid tank are not mutually connected and thus keeping the main piston staying still when the button on the handle is not manually depressed, leaving the handle at its initial immobile position;
whereas, when the button on the handle is depressed, the rigid drawing element pushes down the auxiliary piston, which further compresses the spring disposed between a lower end of the auxiliary piston and a bottom end of a central pit of the main piston so that the fourth O-ring of the auxiliary piston lowers below the horizontal channel of the lower channel; thus the upper channel and the lower channel are in fluid communication, and the upper fluid tank and the lower fluid tank are therefore in fluid communication.

4. The fluid controlled luggage handle of claim 1, wherein the rigid drawing element is of a depression type and the upper portion of the central pit of the main piston is open.

5. The fluid controlled luggage handle of claim 1, wherein the rigid drawing element is of a pull type and the lower portion of the central pit of the main piston is open.

6. The fluid controlled luggage handle of claim 1, wherein the bottom of the outer tube is further provided with a one-way valve.

7. The fluid controlled luggage handle of claim 1, wherein the bottom of the upper and lower fluid tanks of the outer tube are airtight.

8. The fluid controlled luggage handle of claim 1, wherein the lower fluid tank of the outer tube is open.

9. The fluid controlled luggage handle of claim 2, wherein the rigid drawing element is of a depression type and the upper portion of the central pit of the main piston is open.

10. The fluid controlled luggage handle of claim 2, wherein the rigid drawing element is of a pull type and the lower portion of the central pit of the main piston is open.

11. The fluid controlled luggage handle of claim 2, wherein the bottom of the outer tube is further provided with a one-way valve.

12. The fluid controlled luggage handle of claim 2, wherein the bottom of the upper and lower fluid tanks of the outer tube are airtight.

13. The fluid controlled luggage handle of claim 2, wherein the lower fluid tank of the outer tube is open.

14. The fluid controlled luggage handle of claim 3, wherein the rigid drawing element is of a depression type and the upper portion of the central pit of the main piston is open.

15. The fluid controlled luggage handle of claim 3, wherein the rigid drawing element is of a pull type and the lower portion of the central pit of the main piston is open.

16. The fluid controlled luggage handle of claim 3, wherein the bottom of the outer tube is further provided with a one-way valve.

17. The fluid controlled luggage handle of claim 3, wherein the bottom of the upper and lower fluid tanks of the outer tube are airtight.

18. The fluid controlled luggage handle of claim 3, wherein the lower fluid tank of the outer tube is open.
